(19) United States
(12) Patent Application Publication
(10) Pub. No.: US 2003/0200457 A1
(43) Pub. Date: Oct. 23, 2003

(54) Enhancement to the MCS lock for increased functionality and improved programmability

(75) Inventors: Marc A. Auslander, Millwood, NY (US); David Joel Edelsohn, White Plains, NY (US); Orran Yaakov Krieger, Newton, MA (US); Bryan Savoye Rosenburg, Cortlandt Manor, NY (US); Robert W. Wisniewski, Yorktown Heights, NY (US)

Correspondence Address: Louis J. Percello, Intellectual Property Law Dept., IBM Corporation, P.O. Box 218, Yorktown Heights, NY, 10598, US

(73) Assignee: International Business Machines Corporation, Armonk, NY (US)

(21) Appl. No.: 10/128,745

(22) Filed: Apr. 23, 2002

(51) Int. Cl. H04L 9/00

(52) U.S. Cl. 713/200

(57) ABSTRACT

A method for allowing a system programmer using a computing system to efficiently use a queuing lock without the requirement of pre-allocating qnode structures for each possible thread of computation expecting to use the lock. More specifically, the lock structure of this invention uses two pointers: a head pointer that points to the next qnode structure representing the next thread or process interested in acquiring the lock, and a tail pointer pointing to the qnode structure representing the last thread or process in a queue of threads or processes awaiting to acquire the lock. When the lock is released, a flag is changed in the qnode structure of the next thread in line (pointed to by the head of the lock) indicating that thread now has the lock and may proceed. A thread or process obtains the lock by spinning on a flag in a qnode structure representing such thread or process. That is, when the flag of a qnode structure is observed to be in a certain state, the thread represented by that qnode structure acquires that lock. The lock now points to the next qnode structure representing the next thread or process that has acquired the lock and to the last qnode structure representing the last thread or process interested in acquiring the lock. A joining thread joins the queue of threads waiting to acquire the lock by changing the tail pointer of the lock to point to a qnode structure representing the joining thread and the head pointer of the previous last thread's qnode structure in the queue to point to the joining thread.

### TECHNICAL FIELD

This invention relates to the field of synchronization in a multiprocessor environment. More specifically, this invention relates to a locking/unlocking mechanism for providing mutual exclusion in a computer system.

### BACKGROUND OF THE INVENTION

When running applications or operating systems in a multithreaded or multiprocessing environment, different threads or processes may want to access the same piece of memory. If they do not coordinate (synchronize) when doing so, then accesses to that memory may produce erroneous results, such as when read accesses and write accesses by one thread of control are interleaved with read and write accesses of another thread of control. The code that performs these accesses must be protected by mutual exclusion locks that guarantee only one thread of control is allowed to modify the data at any given time. The MCS lock provides mutual exclusion. Another form of synchronization primitives, known as barrier synchronization, is used to allow a group of processes to all reach a threshold point in the program before any of them continue beyond the threshold. This patent application pertains to mutual exclusions locks.

The algorithm used for performing synchronization can have a dramatic impact on performance. In a multiprocessor system the importance of choosing the correct type of synchronization primitive is even more important. If a naive approach is taken, the programs can slow down by 1000 times rendering them virtually useless. In 1991 Mellor-Crummey and Scott (MCS) proposed an MCS lock for solving many of the difficulties involved in performing synchronization on a multiprocessor. See Mellor-Crummey, J. M., and Scott, M. L., Algorithms for Scalable Synchronization on Shared-Memory Multiprocessors, ACM Transactions on Computer Systems, Vol. 9, No. 1, February, 1991, pp.21-65. The MCS lock became known and gained widespread usage throughout the parallel computing community. U.S. Pat. No. 6,247,025 to Bacon discloses using queue locks to achieve scalable synchronization. This patent is hereby incorporated herein by reference. Bacon uses a cheaper spin lock when only one thread has the lock and switches to a more expensive (but scalable) queued lock when there is contention.

The MCS lock provides a FIFO (First In First Out) lock discipline for blocking or spin locks. Its key innovation is allowing each thread of control to spin on a local location, thus reducing contention among processors. The algorithm uses a non-blocking technique for managing a queue of waiters. The MCS lock is represented by a pointer to the tail of a list of lock control structures, called qnode structures. A free lock is represented by a null pointer or by a value denoting zero or empty. To acquire a free lock, a holder of a qnode structure or queue element uses a non-blocking atomic operation such as an atomic compare and swap to convert the null pointer of the free lock to a pointer to the holder's queue element. Each queue element contains a pointer only to the next qnode in the queue and information on how to pass the lock to that thread and tell it that it's done waiting (i.e., it has the lock). To start the algorithm, the holder's queue element's next pointer is initialized to null.

If a requester finds the lock held (pointer not null), it uses a non-blocking atomic operation to convert the lock, which points to the tail of the queue, to a pointer to the requester's qnode. The requester then updates the previous tail's next pointer to point to the requester. Finally, the requester blocks or spins on another field in the qnode waiting for the thread prior to it in the queue to pass it the lock. The requestor is now in the queue of threads wanting to acquire the lock.

When the lock holder releases the lock, there are two cases. If the lock still points to the holder's qnode, there are no waiters. The holder does a non-blocking conversion of the lock pointer back to null. If there are waiters, the holder spins if necessary until its qnode's next pointer is not null (to avoid the timing window where a thread has registered itself in the queue but has not yet provided information about how to be notified when the previous thread is granting it the lock). The holder then unblocks the waiter identified by the next pointer, either by issuing an unblock for the waiter identified in the request structure, or by modifying the spin value in the request structure to the value the waiter is waiting for.

There are several difficulties both in terms of the functionality that the MCS lock provides and the programming model it requires. In the referenced formulation, the qnode must be allocated outside of the locking routines, i.e., prior to calling the function implementing the lock. The qnodes's address is passed to both the acquire and release f unctions. This causes a number of programming difficulties. First, because the interface requires the address of the qnode, the code/programmer using the MCS lock is forced to be aware of the requirement for a qnode, making it difficult to replace other lock mechanisms with an MCS lock. Worse, if the lock acquire and release occur in separate functions, then the code/programmer that is intending to use the MCS must provide the qnode (i.e., they are responsible for allocating it). Other potential problems arise if the lock needs to be accessed at a low level in the operating system where allocating additional memory is not possible. This need and other difficulties often lead to pre-allocation of qnodes. Further, even where allocation is available, it can add a significant cost to the acquisition of a lock. Mellor-Crummey and Scott suggest that a qnode be associated with each thread for each lock, but such an association is a vast over commitment of resources in the normal case when most locks are uncontended.

### SUMMARY OF THE INVENTION

It is therefore an object of this invention to eliminate the need for pre-allocation of qnode structures for each thread attempting to acquire a lock. Elimination of such structures allows the lock to be used at a low level in the operating system where memory allocation is not available. Allocation during acquisition also eliminates the need for knowledge of the type of locking mechanism outside of the locking routines.

This invention provides a better programming model for the MCS lock because it does not require users outside the lock structure to be aware of the internal structure of the lock.

This invention provides a better programming model for the MCS lock because the qnode address does not need to be passed into both the acquirer and releaser of the lock, thereby eliminating the need to create a specific type of structure.

Accordingly, this invention provides for a representation of the lock to have two pointers rather than just the single pointer as in the original MCS lock. One pointer serves the same purpose as in the MCS, namely indicating the tail of the queue. The other pointer of lock represented by the qnode is used by the thread holding the lock to record the head of the queue of waiting qnodes. (When the qnode represents a thread waiting in the queue the second field is used to represent a waiting word). By adding this additional field to the qnode, the need for pre-allocation of qnode structures is eliminated. The memory for this qnode structure is allocated from the stack by compiler; no malloc routine need be called. This ability to dynamically allocate a qnode prevents the difficulties that arise out of requiring pre-allocation.

### BRIEF DESCRIPTION OF THE DRAWINGS

FIG. 1 represents the basic C declaration for the lock structure and the pictorial view of that structure

FIG. 2 represents different states that a lock can assume. It can be unlocked (no threads requiring the lock to proceed with computation), locked no waiters (this thread/process is the only one requiring the lock to proceed with computation), or locked with waiters (other threads/processes including this one require the lock to proceed with computation).

FIG. 3 shows how to move between the different states of a lock, including what action needs to be taken when a transition occurs.

FIG. 4 is C code that can be used for an implementation of the invention.

FIG. 5 is a flow chart describing the steps involved in acquiring, using, and releasing a lock.

### DESCRIPTION OF PREFERRED EMBODIMENT

Implementing any synchronization primitive can be a challenging process as there are many opportunities for timing windows to cause difficult-to-track bugs. However, given a familiarity with the well-known MCS lock and the C code presented in the figures, the implementation of the lock described in this invention is straight forward. In addition, the other figures provide semantic meaning for understanding the code. For the sake of discussion, throughout this section, we shall use the term thread for the entity that is using the lock. This entity could be a thread, process, or any other entity representing a piece of computation executing on computer. Atomic primitives are assumed to be implemented in hardware as is true on modem architectures. The specific one used is compare and swap. If the architecture of concern provides only 11/cs (load-linked and store conditional) or other base atomic primitives, a compare and swap can be designed using the base primitives as described in any standard parallel programming text. Throughout this text we will use the term, timing window, as is standardly used to refer two series of instructions that have a different outcome depending on the order in which they are interleaved. It is necessary to avoid timing windows to guarantee correct programs. Timing windows can occur on a uniprocessor because of preemption or on a multiprocessor either because of preemption or because of simultaneous executing on different processors.

In contrast to the MCS implementation, in our representation of the lock there are two pointers. When we refer to the lock, we mean this qnode structure that is the head of the queue. However, at times in this document we refer to the combination of the qnode that is the head, and the qnodes in the queue, as the lock. Each qnode has two fields. When a qnode represents the lock (it is the head of the queue), it's two fields are the two pointers, head and tail as described. When the qnode represents a waiting thread in the queue, the second field is used to hold the waiting identifier that the thread spins on to determine when it is granted the lock. If there are no threads that are waiting or that have acquired the lock, we say the lock is unlocked.

The acquisition of a lock up into two phases: one phase indicating that a thread wants to acquire a lock and the other phase indicating the actual accepting of a granted lock. In a queue-locking implementation, there is a period where a thread has registered (attempted to acquire) its interest in the lock, but does not yet own it. We define when the thread actually receives the lock as the “accepting of a granted lock”.

Lock primitives need to be called from code that an application a programmer writes. The primitives needed are a lock (acquire) and unlock (release). Thus, the routines provided in this invention are the acquire and release routines for a lock. Anyone skilled in the art of programming understands that sometimes references to variables or portions of code can be executed by at most one thread simultaneously, otherwise the resulting programs are incorrect. Accesses to the data must be mutually exclusive. To do so threads must acquire a lock before accessing the data and then release a lock upon completion. The implementation provided in an lock acquisition routine, including the code provided in this invention disclosure, allows only one thread to acquire the lock at any given time. As the code finishes accessing the data, it must release the lock. If it does not, then any other thread attempting to acquire the lock will wait forever and not make forward progress.

The concept of a queued lock is that threads “line up” waiting for the lock. As above, the phase of indicating interest in the lock involves a thread placing itself in the queue. It does this by modifying fields of qnodes that are already in the queue. Specifically, a new thread coming into the queue, needs to modify the qnode of the last thread in line to indicate that this new thread is now the last thread. Also, in this invention, the tail of the lock must be modified as well because it points to the last thread in the queue. The releasing of a lock involves a thread leaving the queue. Specifically, it needs to modify the qnode fields of the next thread in the queue to indicate that this next thread now has the lock.

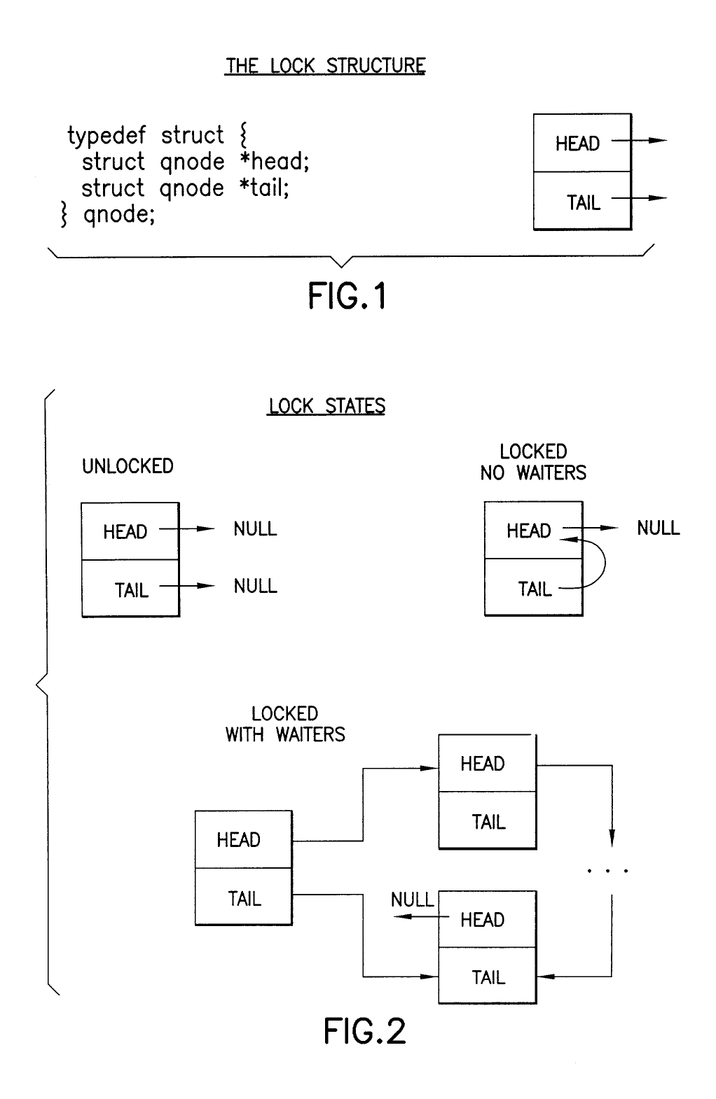

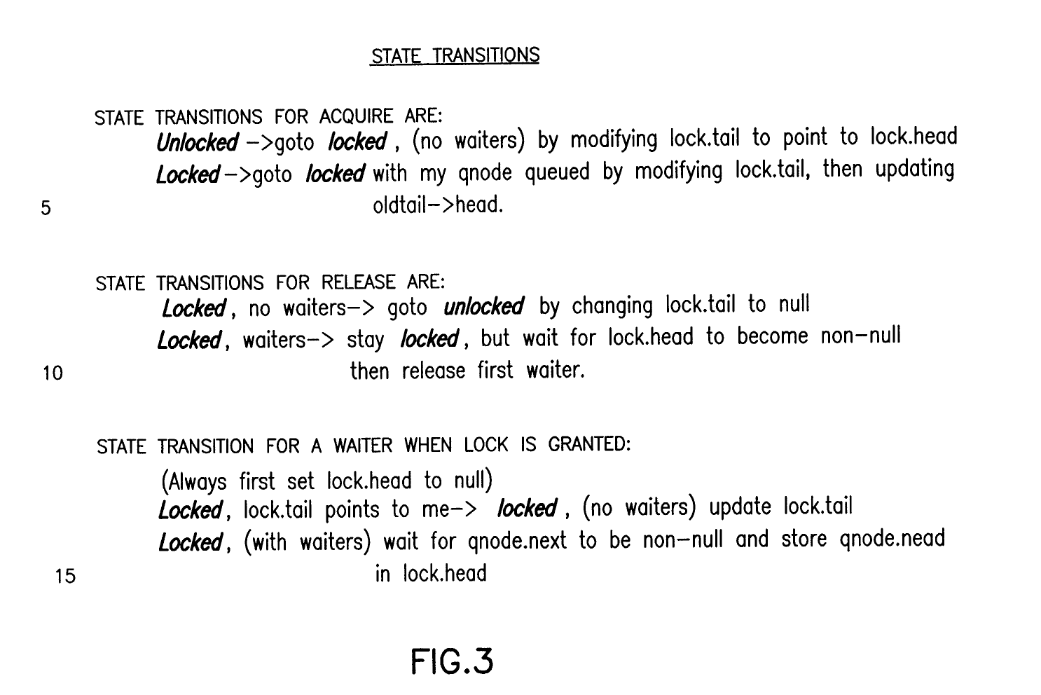

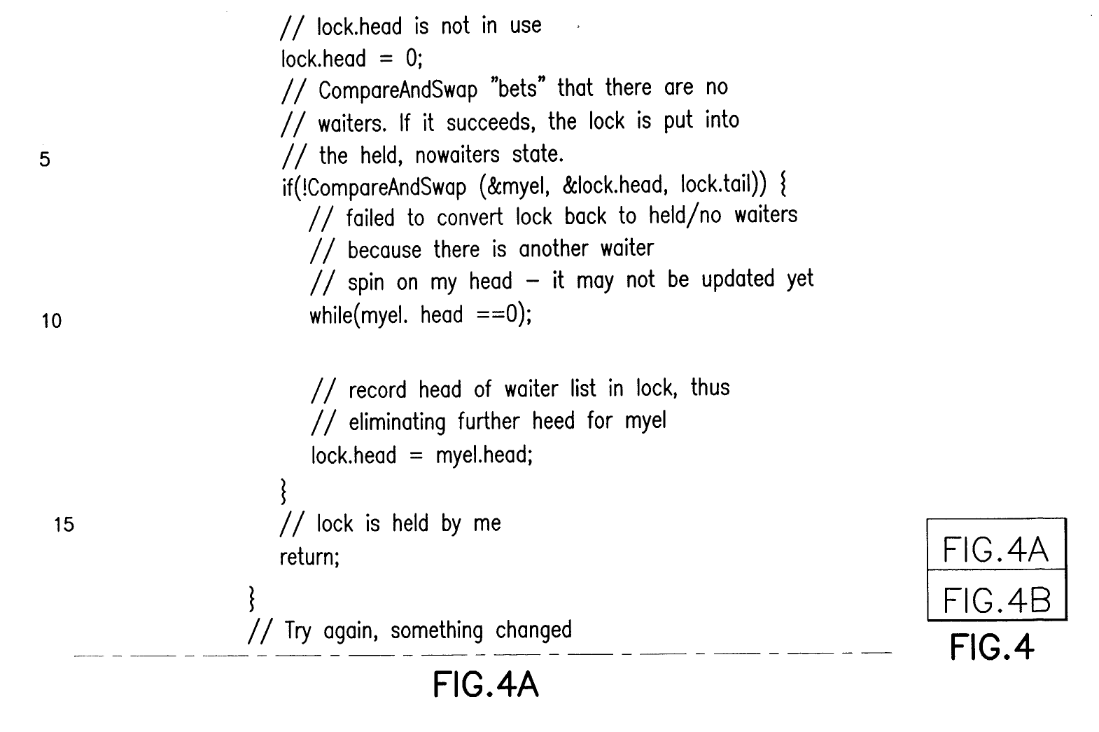

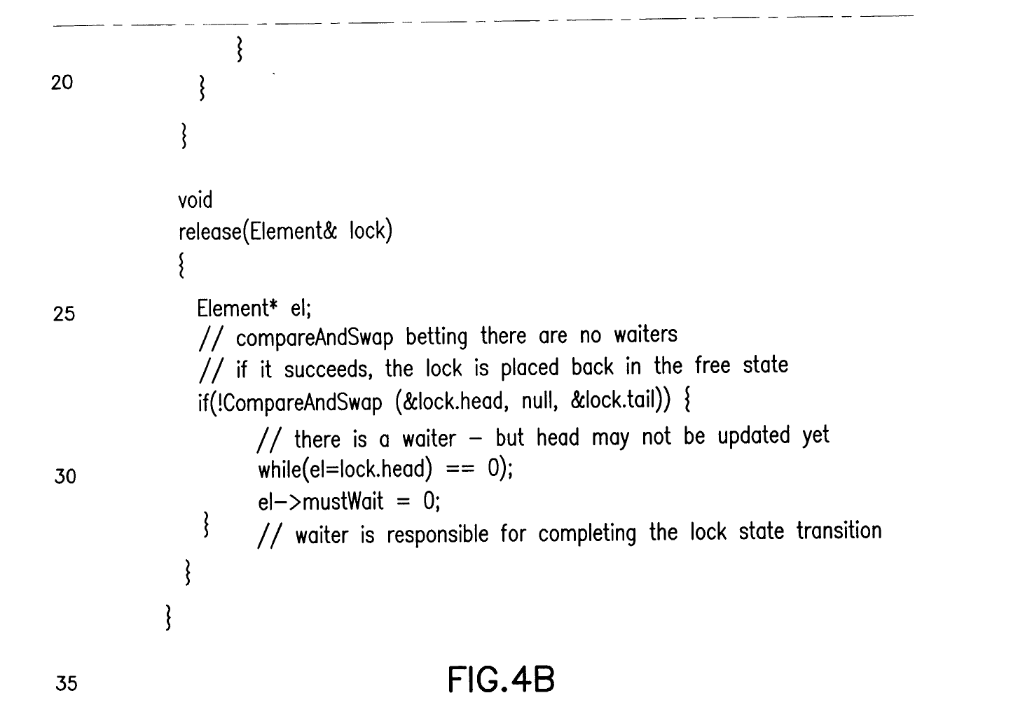

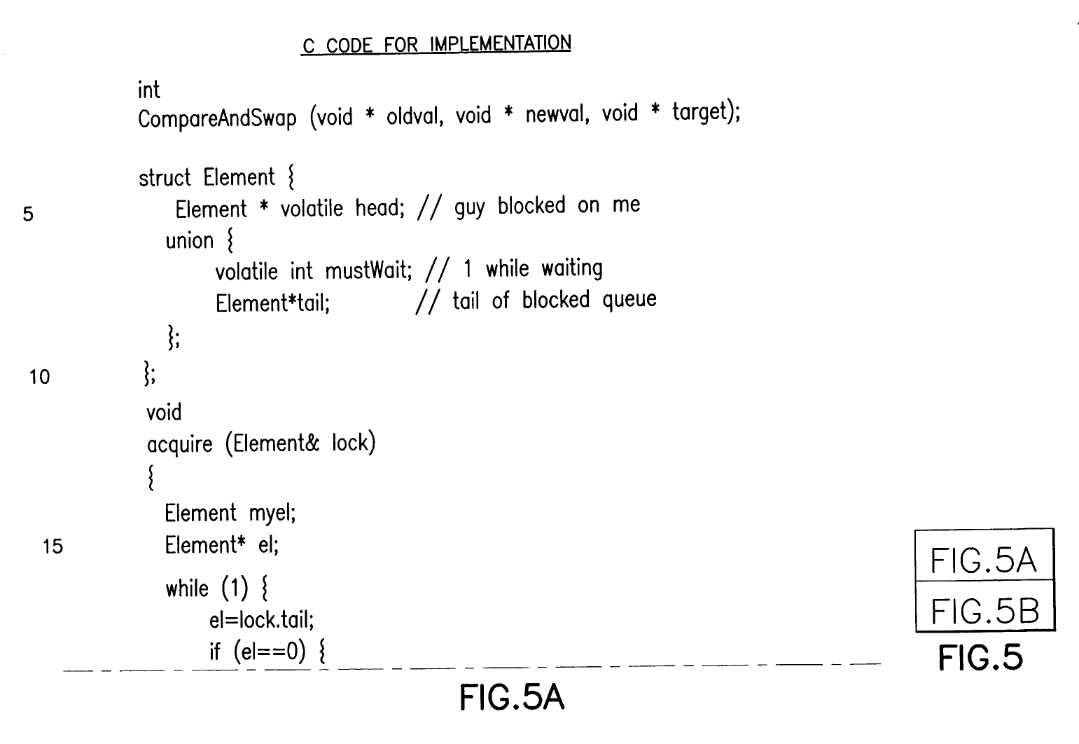

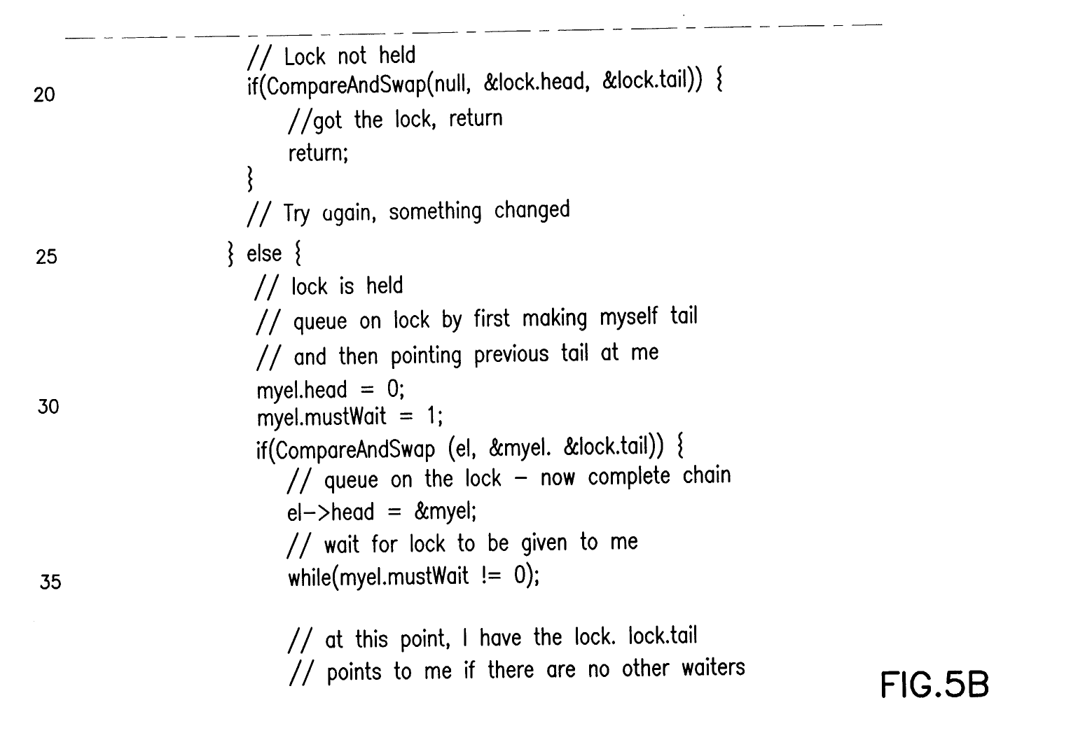

Referring to FIG. 1, to implement a lock, first, a structure 101 or graphic representation 102 must be declared (lines 4-10 of FIG. 4). Referring to FIG. 2, the qnode representing the lock 201 should be initialized with both the head and tail fields defined to be null. The first operation a thread performs is to attempt to acquire a lock as in 501 of FIG. 5. When a first thread acquires the lock, the code recognizes that both fields of the lock are null and modifies the tail pointer of the lock to point to the head of the lock while the pointer in the head of the lock remains null. See 301 of FIG. 3, 550 of FIG. 5, and lines 021-022 of FIG. 4. The thread is in state 504 of FIG. 5. If the first thread releases the lock before any other thread attempts to acquire it, the thread simply sets the tail pointer of the lock back to null. See transition 551 of FIG. 5 or 303 of FIG. 3. If, while the first thread is holding the lock, a second thread attempts to acquire the lock, then the second thread enqueues itself on the lock by modifying the tail of the lock (lock.tail) to point to a qnode structure that the second thread will spin on. See 302 of FIG. 3, 552 of FIG. 5, and line 031 of the acquire routine in FIG. 4. After successfully performing the spin operation as determined by the value returned by compare and swap (line 007 of the acquire routine in FIG. 4), the second thread modifies the head pointer of the previous qnode structure in the queue of qnode structures representing threads waiting to acquire the lock. The modifications made to the lock and qnode must be made in the order described above; otherwise, a timing window is introduced. That second thread now enters a wait state as in 502 of FIG. 5. The code then spins until it has been notified it has the lock (line 035 of FIG. 4). Upon releasing a lock held by multiple threads, where the tail pointer is not pointing to the head, a first thread waits for its head pointer (this is implicitly the head pointer of the lock at this point) to become non-null (line 110 of the acquire routine in FIG. 4) (remember the crucial order described in the acquire) and then grants the lock to a second thread pointed to by its head (transition 553 or 304). The reason the first thread needs to wait for the pointer to become non-null is because it is possible that just as the first thread was about to release the lock a new thread started acquiring the lock. If this was the case, then as the crucial order described in the acquire dictates, the first action the thread performs is to indicate that it is entering the queue. The last action the thread performs is to set the head pointer of the previous thread in the queue. This occurs only after it has fully registered itself in the queue. Note, in most circumstances the head pointer will be non-null upon first check, but it is critical to make the check and wait on the condition. The granting of a lock occurs by setting the waiting bit of next thread in line (line 131 of the release function in FIG. 4). When one thread is granted a lock via another thread releasing the lock (i.e., moves from state 503 of FIG. 5 to state 504 of FIG. 5), that one thread must perform several tasks. It first sets the head pointer to null. Then, if lock.tail points to its own structure (the qnode representing itself in the queue), the thread updates the tail pointer to point to its head since it is the only thread in the queue. The updated tail pointer is shown in 202 of FIG. 2. See 305 and 554 of FIGS. 3 and 5 respectively. Otherwise, (lock.tail does not point to its own structure), the one thread waits for the head pointer of its qnode to become non-null (as above, this is to ensure if a thread is in the process of inserting itself on the queue that it completes the entire operation before a pointer gets set to it) and updates the head pointer of the lock with whatever is in the head pointer of the qnode structure representing the one thread (transition 555 or 306). In FIG. 2, qnode 204 represents the addition of another qnode 205 to the queue of waiting threads that was previously in the state illustrated by item 203. More specifically, item 205 is the additional qnode that has been added to the queue. The addition of dotted qnode 205 in FIG. 2 is the result of a thread adding itself to the queue. This figure shows the updated pointers; both the head pointer from qnode 206 and the tail pointer from qnode/lock 204 has been updated.

To implement the ability for the qnode to be able to use its local stack frame (i.e., to not have to allocate memory), a qnode structure is declared as a local variable in the procedure implementing the acquire as shown on line 004 of FIG. 4. To dynamically allocate a qnode (i.e., not having to have pre-allocate qnodes), a qnode structure is declared as a local variable in the procedure implementing the acquire as shown on line 014 of FIG. 4. Since the memory is allocated from the stack by compiler, no malloc routine need be called. If this were not the case, and we wanted to use a lock at a low level in the operating system, where we could not allocate memory; we would need to pre-allocate qnodes. This ability to dynamically allocate a qnode prevents the difficulties that arise out of requiring pre-allocation.

To allow general use of this locking routine, i.e., to allow application code to use these routines without having to know about qnodes, the structure as shown on line 014 of FIG. 4 would be wrapped by another structure that declares the lock variable. Then, on acquire and release the lock variable shown as a parameter to the implementation would be part of the wrapper structure and acquire and release would not take any parameters and would use the lock variable of the wrapper structure.

There are several mechanisms by which users could have access to the code needed to acquire, release, and grant the lock as described in this section. An easy and common way would be to place this code into a library that a user has the capability to link against. Also note, that while the code described above was designed for a spinning lock, it could easily be modified to perform a blocking lock by making modifications in the appropriate spots (i.e., yielding the processor rather than spinning and waiting on a value) Specifically, replace the “while(myel.mustWait!=0);” line with “while(myel.mustWait!=0) yield( );” on line 035 of FIG. 4.

1. In a computer system using a lock to gain access to data, wherein said lock is held by a holding entity and there are no other entities waiting for said lock, a method of acquiring said lock by a first entity, said method comprising:
modifying a tail pointer of said lock to point to a data structure representing said first entity; and
modifying a head pointer of said lock to point to said data structure representing said first entity, wherein said lock is acquired by said first entity when said holding entity changes a waiting identifier in said data structure, which is pointed to by said modified head pointer, wherein said first entity waits until it acquires said lock before said first entity gains access to said data.

2. A method as recited in claim 1, wherein said first entity comprises any one of the following: a thread, a process, or any other identifier representing a piece of computation executing on computer.

3. A method as recited in claim 2, wherein said first entity waits for said lock by spinning on said waiting identifier.

4. A method as recited in claim 3, wherein said waiting identifier is any one of the following: a flag, and an entity identifier.

5. A method as recited in claim 1, wherein said first entity waits for said lock by blocking on said waiting identifier.

6. A method as recited in claim 1, wherein said first entity waits by spinning and then blocking on said waiting identifier.

7. A method as recited in claim 1, wherein said data comprises a location in memory.

8. In a computer system using locks to gain access to data, a method of acquiring a lock by a first entity, said method comprising:
if no entity is currently holding said lock, then modifying a tail pointer of said lock to point to said lock, where said modification indicates that said lock was acquired by said first entity;
if said lock is held and there are no waiting entities, modifying a head pointer and said tail pointer of said lock to point to a data structure representing said first entity, wherein said lock said lock is acquired by said first entity when a holding entity changes a waiting identifier in said data structure, which is pointed to by said modified head pointer,
wherein said first entity waits until said holding entity grants said lock to said first entity before said first entity gains access to said data; and
if said lock is held and there are entities waiting to acquire access to said lock, granting said lock by a holding entity to said first entity by changing a waiting identifier in said data structure, which is pointed to by said modified head pointer, wherein said first entity waits until latter said holding entity grants said lock to said first entity before said first entity gains access to said data.

9. A method as recited in claim 8, wherein, is said lock is held, and if said there are entities waiting to acquire access to said lock, updating said tail pointer of said lock to point to an acquiring entity and updating a the head pointer of an that was previously pointed to by said tail pointer to point to said acquiring entity.

10. A method as recited in claim 8, wherein said first entity comprises any one of the following: a thread, a process, or any other identifier representing a piece of computation executing on computer.

11. A method as recited in claim 8, wherein said first entity waits by spinning on said waiting identifier.

12. A method as recited in claim 10, wherein said waiting identifier is any one of the following a flag, and an entity identifier.

13. A method as recited in claim 8, wherein said first entity waits by blocking on said waiting identifier.

14. A method as recited in claim 8, wherein said first entity waits by spinning and then blocking on said waiting identifier.

15. A method as recited in claim 8, wherein said data comprises a location in memory.

16. In a computer system, a method of releasing a lock, said method comprising:
modifying a head pointer of said lock to point to one of a plurality of waiting entities if there are at least two waiting entities, wherein said lock is released to another of said entities by changing a waiting identifier in a data structure which was pointed to by said head pointer before it was modified;
modifying said head pointer and a tail pointer of said lock to a designated value if there are no waiting entities, wherein said designated value in said head pointer and in said tail pointer indicates that there are no longer any entities holding or waiting to acquire said lock; and
modifying said head pointer of said lock to a designated value if there is one waiting entity, wherein said lock is released to said one waiting entity by changing a waiting identifier in a data structure representing said one entity, and wherein a tail pointer of said lock is modified to point to said data structure indicating said lock is now held by said one entity, and wherein said designated value indicates that there are no longer any entities waiting to acquire said lock.

17. In a computer system using locks to gain access to data, a method of acquiring and releasing a lock by a first entity, wherein said first entity can gain access to said data when it acquires said lock, and wherein when a lock is released, an entity acquires or can acquire said lock, said method comprising:
acquiring said lock by said first entity by:
if no entity is currently holding said lock, then modifying a tail pointer of said lock to point to said lock, where said modification indicates that said lock was acquired by said first entity;
if said lock is held and there are no waiting entities, modifying a head pointer and said tail pointer of said lock to point to a data structure representing said first entity, wherein said lock said lock is acquired by said first entity when a holding entity changes a waiting identifier in said data structure, which is pointed to by said modified head pointer,
wherein said first entity waits until said holding entity grants said lock to said first entity before said first entity gains access to said data; and
if said lock is held and there are entities waiting to acquire access to said lock, granting said lock by a holding entity to said first entity by changing a waiting identifier in said data structure, which is pointed to by said modified head pointer, wherein said first entity waits until latter said holding entity grants said lock to said first entity before said first entity gains access to said data.
releasing said lock by:
modifying a head pointer of said lock to point to one of a plurality of waiting entities if there are at least two waiting entities, wherein said lock is released to another of said entities by changing a waiting identifier in a data structure which was pointed to by said head pointer before it was modified;
modifying said head pointer and a tail pointer of said lock to a designated value if there are no waiting entities, wherein said designated value in said head pointer and in said tail pointer indicates that there are no longer any entities holding or waiting to acquire said lock; and
modifying said head pointer of said lock to a designated value if there is one waiting entity, wherein said lock is released to said one waiting entity by changing a waiting identifier in a data structure representing said one entity, and wherein a tail pointer of said lock is modified to point to said data structure indicating said lock is now held by said one entity, and wherein said designated value indicates that there are no longer any entities waiting to acquire said lock.

18. A method as recited in claim 17, wherein, is said lock is held, and if said there are entities waiting to acquire access to said lock, updating said tail pointer of said lock to point to an acquiring entity and updating a the head pointer of an that was previously pointed to by said tail pointer to point to said acquiring entity.

19. A computer system for using a lock to gain access to data, wherein said lock is held by a holding entity and there are no other entities waiting for said lock, said system for acquiring said lock by a first entity, said system comprising:
means for modifying a tail pointer of said lock to point a data structure representing said first entity; and
means for modifying a head pointer of said lock to point to said data structure representing said first entity, wherein said lock is acquired by said first entity when said holding entity changes a waiting identifier in said data structure, which is pointed to by said modified head pointer, wherein said first entity waits until it acquires said lock before said first entity gains access to said data.

20. A system as recited in claim 19, wherein said first entity comprises any one of the following: a thread, a process, or any other identifier representing a piece of computation executing on computer.

21. A computer system for using locks to gain access to data, said system for acquiring a lock by a first entity, said system comprising:
means for, if no entity is currently holding said lock, then modifying a tail pointer of said lock to point to said lock, where said modification indicates that said lock was acquired by said first entity;
means for, if said lock is held and there are no waiting entities, modifying a head pointer and said tail pointer of said lock to point to a data structure representing said first entity, wherein said lock said lock is acquired by said first entity when a holding entity changes a waiting identifier in said data structure, which is pointed to by said modified head pointer, wherein said first entity waits until said holding entity grants said lock to said first entity before said first entity gains access to said data; and
means for, if said lock is held and there are entities waiting to acquire access to said lock, granting said lock by a holding entity to said first entity by changing a waiting identifier in said data structure, which is pointed to by said modified head pointer, wherein said first entity waits until latter said holding entity grants said lock to said first entity before said first entity gains access to said data.

22. A system as recited in claim 21, wherein said first entity comprises any one of the following: a thread, a process, or any other identifier representing a piece of computation executing on computer.

23. A system as recited in claim 21, wherein said first entity waits by spinning on a waiting identifier.

24. A computer system for releasing a lock, said system comprising:
means for modifying a head pointer of said lock to point to one of a plurality of waiting entities if there are at least two waiting entities, wherein said lock is released to another of said entities by changing a waiting identifier in a data structure which was pointed to by said head pointer before it was modified;
means for modifying said head pointer and a tail pointer of said lock to a designated value if there are no waiting entities, wherein said designated value in said head pointer and in said tail pointer indicates that there are no longer any entities holding or waiting to acquire said lock; and
means for modifying said head pointer of said lock to a designated value if there is one waiting entity, wherein said lock is released to said one waiting entity by changing a waiting identifier in a data structure representing said one entity, and wherein a tail pointer of said lock is modified to point to said data structure indicating said lock is now held by said one entity, and wherein said designated value indicates that there are no longer any entities waiting to acquire said lock.

25. A computer system using locks to gain access to data, said system acquiring and releasing a lock by a first entity, said system comprising:
means for acquiring said lock comprising:
means for, if no entity is currently holding said lock, then modifying a tail pointer of said lock to point to said lock, where said modification indicates that said lock was acquired by said first entity;
means for, if said lock is held and there are no waiting entities, modifying a head pointer and said tail pointer of said lock to point to a data structure representing said first entity, wherein said lock said lock is acquired by said first entity when a holding entity changes a waiting identifier in said data structure, which is pointed to by said modified head pointer, wherein said first entity waits until said holding entity grants said lock to said first entity before said first entity gains access to said data; and
means for, if said lock is held and there are entities waiting to acquire access to said lock, granting said lock by a holding entity to said first entity by changing a waiting identifier in said data structure, which is pointed to by said modified head pointer, wherein said first entity waits until latter said holding entity grants said lock to said first entity before said first entity gains access to said data;
means for releasing said lock comprising:
means for modifying a head pointer of said lock to point to one of a plurality of waiting entities if there are at least two waiting entities, wherein said lock is released to another of said entities by changing a waiting identifier in a data structure which was pointed to by said head pointer before it was modified;
means for modifying said head pointer and a tail pointer of said lock to a designated value if there are no waiting entities, wherein said designated value in said head pointer and in said tail pointer indicates that there are no longer any entities holding or waiting to acquire said lock; and
means for modifying said head pointer of said lock to a designated value if there is one waiting entity, wherein said lock is released to said one waiting entity by changing a waiting identifier in a data structure representing said one entity, and wherein a tail pointer of said lock is modified to point to said data structure indicating said lock is now held by said one entity, and wherein said designated value indicates that there are no longer any entities waiting to acquire said lock.

26. A program storage device readable by a computer, tangibly embodying a program of instructions executable by said computer to perform method steps for using a lock to gain access to data, wherein said lock is held by a holding entity and there are no other entities waiting for said lock, a to perform method steps for acquiring said lock by a first entity, said steps comprising:
modifying a tail pointer of said lock to point to a data structure representing said first entity; and
modifying a head pointer of said lock to point to said data structure representing said first entity, wherein said lock is acquired by said first entity when said holding entity changes a waiting identifier in said data structure, which is pointed to by said modified head pointer, wherein said first entity waits until it acquires said lock before said first entity gains access to said data.

27. A program storage device readable by a computer, tangibly embodying a program of instructions executable by said computer to perform method steps for using locks to gain access to data, said method for acquiring a lock by a first entity, said method comprising:
if no entity is currently holding said lock, then modifying a tail pointer of said lock to point to said lock, where said modification indicates that said lock was acquired by said first entity;
if said lock is held and there are no waiting entities, modifying a head pointer and said tail pointer of said lock to point to a data structure representing said first entity, wherein said lock said lock is acquired by said first entity when a holding entity changes a waiting identifier in said data structure, which is pointed to by said modified head pointer, wherein said first entity waits until said holding entity grants said lock to said first entity before said first entity gains access to said data; and
if said lock is held and there are entities waiting to acquire access to said lock, granting said lock by a holding entity to said first entity by changing a waiting identifier in said data structure, which is pointed to by said modified head pointer, wherein said first entity waits until latter said holding entity grants said lock to said first entity before said first entity gains access to said data.

28. A program storage device readable by a computer, tangibly embodying a program of instructions executable by said computer to perform method steps for releasing a lock, said method comprising:
modifying a head pointer of said lock to point to one of a plurality of waiting entities if there are at least two waiting entities, wherein said lock is released to another of said entities by changing a waiting identifier in a data structure which was pointed to by said head pointer before it was modified;
modifying said head pointer and a tail pointer of said lock to a designated value if there are no waiting entities, wherein said designated value in said head pointer and in said tail pointer indicates that there are no longer any entities holding or waiting to acquire said lock; and
modifying said head pointer of said lock to a designated value if there is one waiting entity, wherein said lock is released to said one waiting entity by changing a waiting identifier in a data structure representing said one entity, and wherein a tail pointer of said lock is modified to point to said data structure indicating said lock is now held by said one entity, and wherein said designated value indicates that there are no longer any entities waiting to acquire said lock.

29. A program storage device readable by a computer, tangibly embodying a program of instructions executable by said computer to perform method steps for using locks to gain access to data, said method steps for acquiring and releasing a lock by a first entity, said method steps comprising:
acquiring said lock by said first entity by:
if no entity is currently holding said lock, then modifying a tail pointer of said lock to point to said lock, where said modification indicates that said lock was acquired by said first entity;
if said lock is held and there are no waiting entities, modifying a head pointer and said tail pointer of said lock to point to a data structure representing said first entity, wherein said lock said lock is acquired by said first entity when a holding entity changes a waiting identifier in said data structure, which is pointed to by said modified head pointer, wherein said first entity waits until said holding entity grants said lock to said first entity before said first entity gains access to said data; and
if said lock is held and there are entities waiting to acquire access to said lock, granting said lock by a holding entity to said first entity by changing a waiting identifier in said data structure, which is pointed to by said modified head pointer, wherein said first entity waits until latter said holding entity grants said lock to said first entity before said first entity gains access to said data.
releasing said lock by:
modifying a head pointer of said lock to point to one of a plurality of waiting entities if there are at least two waiting entities, wherein said lock is released to another of said entities by changing a waiting identifier in a data structure which was pointed to by said head pointer before it was modified;
modifying said head pointer and a tail pointer of said lock to a designated value if there are no waiting entities, wherein said designated value in said head pointer and in said tail pointer indicates that there are no longer any entities holding or waiting to acquire said lock; and
modifying said head pointer of said lock to a designated value if there is one waiting entity, wherein said lock is released to said one waiting entity by changing a waiting identifier in a data structure representing said one entity, and wherein a tail pointer of said lock is modified to point to said data structure indicating said lock is now held by said one entity, and wherein said designated value indicates that there are no longer any entities waiting to acquire said lock.
